(19) United States
(12) Patent Application Publication
(10) Pub. No.: US 2019/0096249 A1
(43) Pub. Date: Mar. 28, 2019

(54) INFRASTRUCTURE BASED BACKUP AND EXIT AID

(71) Applicant: Continental Automotive Systems, Inc., Auburn Hills, MI (US)

(72) Inventor: Vivian Swan, Auburn Hills, MI (US)

(73) Assignee: Continental Automotive Systems, Inc., Auburn Hills, MI (US)

(21) Appl. No.: 16/135,934

(22) Filed: Sep. 19, 2018

Related U.S. Application Data
(60) Provisional application No. 62/561,732, filed on Sep. 22, 2017.

(51) Int. Cl. G08G 1/0967; B60Q 9/00; G08G 1/16; B60W 30/09; B60T 7/12

(52) U.S. Cl. CPC G08G 1/096725; B60Q 9/008; G08G 1/166; G08G 1/164; H04W 4/80; B60T 7/12; B60W 2550/10; B60W 2710/18; B60W 30/09

(57) ABSTRACT

Infrastructure-based warning system having the ability to detect cross-traffic long before onboard vehicle sensors, and broadcast a basic safety message (BSM) including the vehicle's global position, velocity, heading, etc. over dedicated short-range communication (DSRC). A vehicle leaving a parking space is able to receive broadcast over DSRC from infrastructure and provide the driver with an HMI warning that it is unsafe to backup. A vehicle exiting from a blind alley way or parking garage may be positioned such that the driver of the vehicle may not see that there is a pedestrian about to cross and that there is cross-traffic. The infrastructure mounted sensor is able to detect the pedestrian and cross-traffic and broadcast their location, velocity, and headings. The vehicle receives the BSM from the infrastructure and provides the driver with an HMI warning that it is unsafe to move out into the crosswalk and road.

### CROSS-REFERENCE TO RELATED APPLICATIONS

This application claims the benefit of Provisional Application 62/561,732, filed Sep. 22, 2017. The disclosure of the above application is incorporated herein by reference.

### FIELD OF THE INVENTION

The invention relates generally to a system which is able to be integrated into local infrastructure, and is able to detect vehicles and pedestrians which may not be readily visible to a driver of a vehicle, and notify the driver that there is a potential danger of a collision, such that the driver of the vehicle may take proper precautions to avoid the collision.

### BACKGROUND OF THE INVENTION

Collisions may occur when a vehicle is forced to blindly back out of a parking space onto an active road. There are situations which may arise where a vehicle is positioned such that sensors, which are part of the vehicle, are unable to detect pedestrians or other oncoming vehicles which present the risk of a collision. The functionality of these sensors may be limited due to the position of other adjacent vehicles or buildings, which may interfere with the ability of the sensors to detect moving objects (i.e., block the sensors from detecting various objects). Because of the potential limitation in the functionality of the sensors which are part of the vehicle, the driver of the vehicle may not be aware of an oncoming vehicle, and a collision may occur.

Prior backup and occluded exit warning systems require vehicles to be equipped with expensive sensors which may easily be damaged in a collision, which increases insurance costs. Prior onboard sensor-based back up aids are also limited by the field of view (FOV) of the sensors which may easily be occluded by other vehicles. In order for onboard sensors to detect a cross-traffic vehicle, the rear of the vehicle must be out from behind adjacent vehicles where the vehicle is at risk of a collision with cross-traffic. Audio/Visual warnings at garage exits only warn pedestrians of exiting vehicles, but do not warn the driver of the vehicle itself of any cross-traffic.

Accordingly, there exists a need for a system which is able to provide information to a driver of a vehicle when the functionality of the sensors of the vehicle have become compromised.

### SUMMARY OF THE INVENTION

Infrastructure mounted sensors (camera or radar-based) have the ability to detect cross-traffic long before onboard vehicle sensors. Such intelligent infrastructure is able to detect cross-traffic and broadcast a basic safety message (BSM) including the vehicle's global position, velocity, heading, etc. over dedicated short-range communication (DSRC). A vehicle leaving a parking space is able to receive broadcast over DSRC from infrastructure and provide the driver with an HMI warning that it is unsafe to backup.

By moving the “sensing” to the infrastructure and only equipping vehicles with a DSRC module (which may be located safely inside the vehicle), consumers and insurance companies are able to save money.

An infrastructure-based system is able to detect cross-traffic from a greater distance than an onboard system and is not occluded by other vehicles.

The present invention provides drivers with warnings before moving out into the crosswalk instead of only warning the pedestrian. Warnings are also given in-vehicle (as opposed to externally), which makes them harder to miss or be ignored. The present invention also provides driver's vehicle cross-traffic warnings.

In one embodiment, a radar or camera mounted to the infrastructure is able to detect an approaching vehicle and broadcast the vehicle's position, velocity, heading etc. as a basic safety message (BSM). This BSM is received by a vehicle located in a parking spot, and used to provide the driver with an alert/HMI warning when it is unsafe to continue backing out of the parking spot.

In another embodiment, the present invention is useful for a vehicle attempting to exit from a blind alley way or parking garage onto a busy street. The driver of the vehicle may not be able to see that there is a pedestrian about to cross and that there is cross-traffic. The infrastructure mounted radar or camera is able to detect the pedestrian and cross-traffic and broadcast their location, velocity, and headings over DSRC as a BSM. The vehicle receives the BSM from the infrastructure and provides the driver with an HMI warning that it is unsafe to move out into the crosswalk and road.

In one embodiment, the present invention is an infrastructure-based warning system, which includes a detection device having at least one sensor and a first communication device. The sensor is operable for detecting one or more objects in a detection area, and the first communication device in electrical communication with the sensor.

The detection device is mounted to at least one infrastructure component, where the infrastructure component is at least one of, but is not limited to, a building, a bridge, a parking structure, and a support structure.

The infrastructure-based warning system also includes a second communication device being part of a first vehicle, and an indicator device. The second communication device in wireless communication with the first communication device, and the indicator device is in electrical communication with the second communication device.

The sensor detects at least one of the location, speed, and direction of a second vehicle, and the sensor sends a signal to the first communication device, and the first communication device sends a signal to the second communication device when there is a potential risk of collision with the second vehicle, and the indicator device provides a warning of the potential risk of collision to the driver of the first vehicle.

In one embodiment, the infrastructure-based warning system is used in a parking area having a plurality of parking spaces, and the first vehicle occupies a one of the plurality of parking spaces, where there is several parked vehicles adjacent one side of the first vehicle, and several parked vehicles adjacent another side of the first vehicle. The second vehicle moves in a direction relative to the first vehicle, and the indicator device generates a warning to the driver of the first vehicle when the first vehicle moves in a direction of travel to exit the parking space and there is a collision risk with the second vehicle.

In one embodiment, the infrastructure-based warning system includes an automatic braking system being part of the first vehicle, the automatic braking system is operable for decelerating the first vehicle independently of driver input, such that the automatic braking system decelerates the first vehicle when there is a potential risk of collision with the second vehicle.

In one embodiment the first vehicle is located between a first building and a second building, and the indicator device generates a warning to the driver of the first vehicle as the first vehicle moves in a direction of travel away from the first building and the second building, and there is a collision risk with the second vehicle.

In another embodiment, a sidewalk is adjacent the first building and the second building, at least a portion of the sidewalk intersects with the direction of travel of the first vehicle. The indicator device generates a warning to the driver of the first vehicle as the first vehicle moves in a direction of travel away from the first building and the second building, and there is a collision risk with one or more pedestrians.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of an infrastructure-based warning system, according to embodiments of the present invention;

FIG. 2 is a diagram of a first example of an infrastructure-based warning system, according to embodiments of the present invention; and

FIG. 3 is a diagram of the second example of an infrastructure-based warning system, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

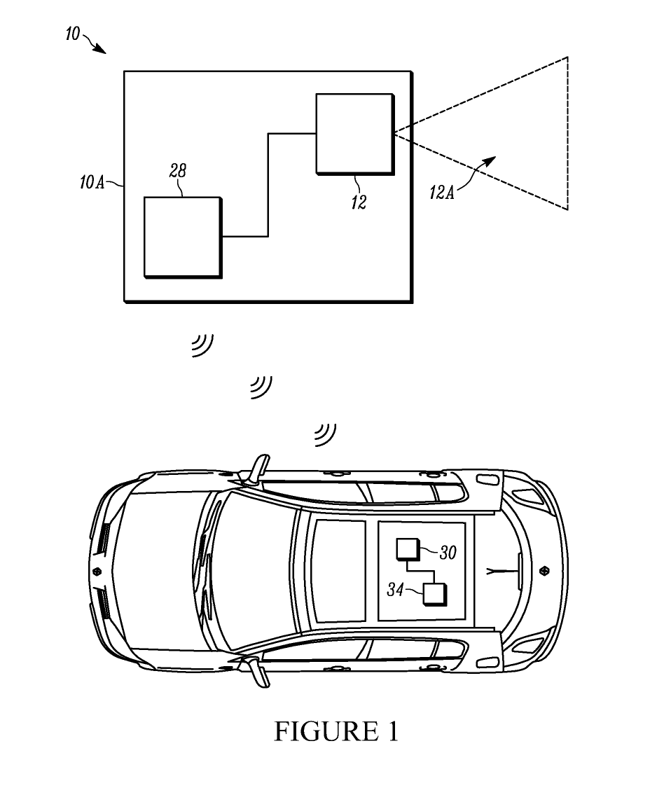

A diagram of an infrastructure-based warning system is shown in FIG. 1, generally at 10. The system 10 includes a back-up assist unit 10A, which has at least one type of detection device, which in this embodiment is a sensor 12. The back-up assist unit 10A is connected to an infrastructure component, which in this embodiment is a post 14. The sensor 12 is able to detect various objects within a detection area, shown generally at 12A. While in this embodiment, the infrastructure component is the post 14, it is within the scope of the invention that the infrastructure-based warning system 10 may include any other type of infrastructure component, such as a building, bridge, parking structure, traffic signal, a sign, support structure, or the like. The back-up assist unit 10A also includes a first communication device 28 in electrical communication with the sensor 12. The first communication device 28 is in wireless communication with a second communication device 30, and the second communication device 30 is in electrical communication with a warning or indicator device 34. The second communication device 30 and indicator device 34 are shown in FIG. 1 as being part of a first vehicle 18. The second communication device 30 and indicator device 34 may be connected to or integrated with the first vehicle 18 in any suitable manner.

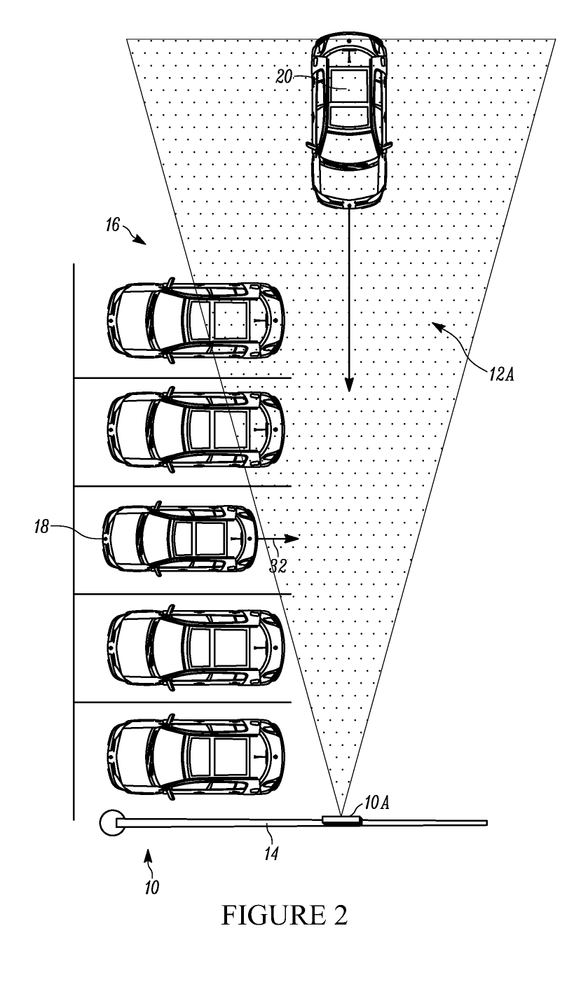

In the example shown in FIG. 2, the system 10 is implemented in a parking area having a plurality of parking spaces, shown generally at 16. Located in the parking area 16 is the first vehicle 18, and the first vehicle 18 includes the second communication device 30. Located on each side of the first vehicle 18 is a plurality of parked vehicles, and the first vehicle 18 is attempting to move in a reverse direction along a path of travel, as indicated by arrow 32, to exit a parking space. There is also a second vehicle 20 moving in a substantially perpendicular direction in the parking area relative to the first vehicle 18, such that the second vehicle 20 is moving in a cross-traffic direction. When the vehicle 18 is in the position shown, the driver of the vehicle 18 may have difficulty seeing the second vehicle 20, and any sensors of the first vehicle 18 may not be able to detect the location and direction of the second vehicle 20.

The sensor 12 is able to detect the location, speed, and direction of the second vehicle 20, and the sensor 12 sends a signal to the first communication device 28, and the first communication device 28 sends a signal to the second communication device 30 indicating that there is a potential risk of collision with the second vehicle 20, such that the driver of the first vehicle 18 may take precautions to prevent the collision. The driver may apply the brakes of the first vehicle 18, or the driver may choose not to attempt to move the vehicle 18 in a reverse direction until the second vehicle 20 has moved a safe distance away from the first vehicle 18. The second communication device 30 is in electrical communication with the warning or indicator device 34. The warning or indicator device 34 may be any type of device used to inform the driver of the first vehicle 18 of the potential danger of a collision with the second vehicle 20. The warning or indicator device 34 may be a telltale light as part of the instrument cluster, or may be an audio, visual, or haptic warning, or any other type of indicator that may notify the driver of a potential risk of collision.

In another embodiment, the first vehicle 20 may also be equipped with an automatic braking system in communication with the second communication device 30, such that when the second communication device 30 receives a signal from the first communication device 28 indicating that there is a potential risk of collision with the second vehicle 20, the automatic braking system may actuate the brakes of the first vehicle 18 to either prevent or stop the first vehicle 18 from moving to avoid a collision with the second vehicle 20.

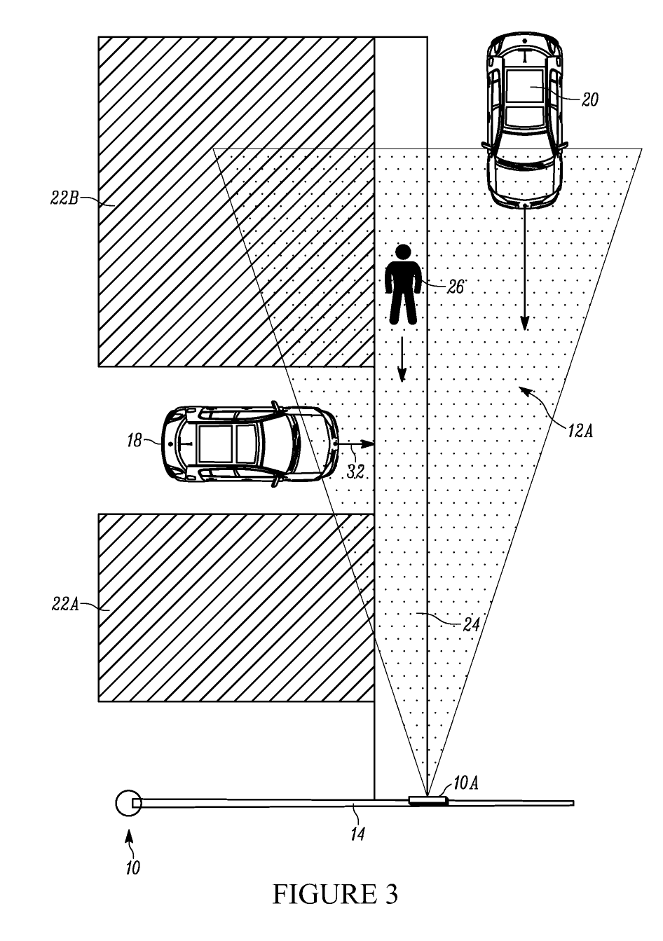

Another example of use of the infrastructure-based warning system 10 is shown in FIG. 3, with like numbers referring to like elements. In the example shown in FIG. 3, however, the first vehicle 18 is located in between two buildings 22A,22B, and there is a sidewalk 24 that extends across the front of both buildings 22A,22B, and a pedestrian 26 is moving across the sidewalk 24. The sensor 12 is able to detect the location, speed, and direction of the second vehicle 20 and the pedestrian 26. The sensor 12 sends a signal to the first communication device 28, and the first communication device 28 sends a signal to the second communication device 30 indicating that there is a potential risk of collision with either of the second vehicle 20 or the pedestrian 26 if the vehicle 18 were to proceed along a path of travel 32, such that the indicator device 34 may provide an indication or warning to the driver of the first vehicle 18, such that the driver of the first vehicle 18 may take precautions to prevent the collision. Again, the driver may apply the brakes of the first vehicle 18, or the driver may choose not to attempt to move the vehicle 18 in a reverse direction until the second vehicle 20 and the pedestrian 26 have moved a safe distance away from the first vehicle 18. Again, if the first vehicle 20 is equipped with an automatic braking system in communication with the second communication device 30, the automatic braking system may actuate the brakes of the first vehicle 18 to either prevent or stop the first vehicle 18 from moving to avoid a collision with the second vehicle 20 or the pedestrian 26 when the second communication device 30 receives a signal from the first communication device 28 indicating that there is a potential risk of collision.

In one embodiment, the sensor 12 is a long-range radar sensor 12, but it is within the scope of the invention that other types of sensors maybe used, such as, but not limited to LIDAR (Light Imaging, Detection, and Ranging), LADAR (Laser Imaging, Detection, and Ranging), other types of radar, a camera, ultrasound, or sonar.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an infrastructure-based warning system, including:
at least one sensor operable for detecting one or more objects in a detection area;
an infrastructure component, the at least one sensor connected to the at least one infrastructure component;
at least one vehicle operable for communication with the at least one sensor; and
a path of travel, the vehicle able to move along the path of travel;
wherein the vehicle receives a signal from the at least one sensor indicating when there is an object approaching the path of travel.

2. The apparatus of claim 1, further comprising:
a detection device being connected to the infrastructure component, the at least one sensor being part of the detection device; and
a first communication device in electrical communication with the at least one sensor, the first communication device being part of the detection device;
wherein the at least one sensor detects at least one of the location, speed, and direction of the one or more objects, and the at least one sensor sends a signal to the first communication device.

3. The apparatus of claim 2, further comprising:
a second communication device in wireless communication with the first communication device, the second communication device being part of the at least one vehicle; and
an indicator device in electrical communication with the second communication device, the indicator device being part of the at least one vehicle;
wherein the first communication device sends a signal to the second communication device when there is a potential risk of collision with the one or more objects, and the indicator device provides a warning of the potential risk of collision to the driver of the at least one vehicle.

4. The apparatus of claim 1, further comprising:
a parking area having a plurality of parking spaces, and the at least one vehicle occupies a first of the plurality of parking spaces; and
a plurality of parked vehicles, a portion of the plurality of vehicles adjacent one side of the at least one vehicle, and another portion of the plurality of vehicles adjacent another side of the at least one vehicle;
wherein the one or more objects move in a direction relative to the at least one vehicle, and the at least one sensor detects the position of the one or more objects in the detection area such that the driver decelerates the at least one vehicle when the at least one vehicle moves in a direction of travel to exit the first of the plurality of parking spaces and there is a collision risk with the one or more objects.

5. The apparatus of claim 1, further comprising:
an automatic braking system being part of the at least one vehicle, the automatic braking system operable for decelerating the vehicle independently of driver input;
wherein the automatic braking system decelerates the at least one vehicle when there is a potential risk of collision with the object.

6. The apparatus of claim 1, further comprising:
a first building; and
a second building, the at least one vehicle being located between the first building and the second building;
wherein the at least one sensor sends a signal to the at least one vehicle when there is a collision risk with the object as the at least one vehicle moves in a direction of travel away from the first building and the second building, such that the driver of the at least one vehicle decelerates the at least one vehicle to avoid a collision.

7. The apparatus of claim 6, the one or more objects further comprising a second vehicle.

8. The apparatus of claim 6, the one or more objects further comprising a pedestrian.

9. The apparatus of claim 1, the at least one infrastructure component being one selected from the group consisting of a building, a bridge, a parking structure, and a support structure.

10. An infrastructure-based warning system, comprising:
a detection device;
at least one sensor operable for detecting one or more objects in a detection area, the at least one sensor being part of the detection device;
a first communication device in electrical communication with the at least one sensor, the first communication device being part of the detection device;
at least one infrastructure component, the detection device being mounted to the at least one infrastructure component;
a second communication device being part of a first vehicle, the second communication device in wireless communication with the first communication device; and
an indicator device being part of the first vehicle, the indicator device in electrical communication with the second communication device;
wherein the at least one sensor detects at least one of the location, speed, and direction of a second vehicle, and the at least one sensor sends a signal to the first communication device, and the first communication device sends a signal to the second communication device when there is a potential risk of collision with the second vehicle, and the indicator device provides a warning of the potential risk of collision to the driver of the first vehicle.

11. The infrastructure-based warning system of claim 10, further comprising:
a parking area having a plurality of parking spaces, and the first vehicle occupies a first of the plurality of parking spaces; and
a plurality of parked vehicles, a portion of the plurality of vehicles adjacent one side of the first vehicle, and another portion of the plurality of vehicles adjacent another side of the first vehicle;
wherein the second vehicle moves in a direction relative to the first vehicle, and the indicator device generates a warning to the driver of the first vehicle when the first vehicle moves in a direction of travel to exit the first of the plurality of parking spaces and there is a collision risk with the second vehicle.

12. The infrastructure-based warning system of claim 10, further comprising:
an automatic braking system being part of the first vehicle, the automatic braking system operable for decelerating the first vehicle independently of driver input;
wherein the automatic braking system decelerates the first vehicle when there is a potential risk of collision with the second vehicle.

13. The infrastructure-based warning system of claim 10, further comprising:
a first building; and
a second building, the first vehicle being located between the first building and the second building;
wherein the indicator device generates a warning to the driver of the first vehicle as the first vehicle moves in a direction of travel away from the first building and the second building, and there is a collision risk with the second vehicle.

14. The infrastructure-based warning system of claim 10, further comprising:
a sidewalk adjacent the first building and the second building, at least a portion of the sidewalk intersecting with the direction of travel of the first vehicle;
a pedestrian traversing the sidewalk; and
wherein the indicator device generates a warning to the driver of the first vehicle as the first vehicle moves in a direction of travel away from the first building and the second building, and there is a collision risk with the pedestrian.

15. The infrastructure-based warning system of claim 10, the at least one infrastructure component being one selected from the group consisting of a building, a bridge, a parking structure, and a support structure.
